(19) United States
(12) Patent Application Publication
(10) Pub. No.: US 2018/0059231 A1
(43) Pub. Date: Mar. 1, 2018

(54) Ultra-Wide Band Radar and Positional Node Integration

(71) Applicant: 5D Robotics, inc., Carlsbad, CA (US)

(72) Inventors: Brandon Dewberry, Huntsville, AL (US); Josh Senna, Carlsbad, CA (US); David Bruemmer, Carlsbad, CA (US)

(73) Assignee: 5D Robotics, Inc., Carlsbad, CA (US)

(21) Appl. No.: 15/675,719

(22) Filed: Aug. 12, 2017

Related U.S. Application Data
(60) Provisional application No. 62/374,171, filed on Aug. 12, 2016.

(51) Int. Cl. G01S 13/00; G01S 13/02

(52) U.S. Cl. CPC G01S 13/003; G01S 13/931; G01S 13/0209

(57) ABSTRACT

A constellation of Ultra-Wide Band (UWB) nodes, each with an UWB transceiver operating both as a monostatic/bi-static Radar, provide precise positional determination of both participating and nonparticipating movable objects. The UWB constellation identifies and locates objects within a geographic area using multipath signal analysis forming an occupancy grid. The resulting occupancy grid can identify parked cars, pedestrians, obstructions, and the like to facilitate autonomous vehicle operations, safety protocols, traffic management, emergency vehicle prioritization, collisions avoidance and the like.

### RELATED APPLICATION

The present application relates to and claims the benefit of priority to U.S. Provisional Patent Application No. 62/374,171 filed 12 Aug. 2016 which is hereby incorporated by reference in its entirety for all purposes as if fully set forth herein.

### BACKGROUND OF THE INVENTION

### Field of the Invention

Embodiments of the present invention relate, in general, to determination of an objects position and surrounding obstacles through integration of Ultra-Wide Band Radar and Ultra-Wide Band Localization capabilities in environments with high multipath clutter.

### Relevant Background

The Global Positioning System revolutionized positional awareness. With relatively inexpensive receivers, an object's location can be easily determined within a certain degree of accuracy. While GPS was a significant leap forward it was, and is, not without its limitations. GPS works well when the receiver can maintain an unobstructed line of sight to four or more GPS satellites. But even with ideal conditions GPS positional accuracy is measured in meters.

Problems quickly arise when the direct line of sight or direct path between the transmitter and receiver is occluded. Moreover, in heavy mountainous environments or in urban canyons, multipath errors occur. Multipath signals are reflections of the original transmission that arrive at the receiver later than a direct path signal. Unfortunately, with GPS signals, it is difficult to distinguish between a direct path signal and a multipath signal. A multipath signal can often mask an occluded or degraded direct path signal resulting in substantial degradation of positional accuracy.

Many efforts have been taken to overcome, reduce and eliminate multipath signals and multipath errors. Positional determinations using Time Domain based Ultra-Wide Band technology present a promising alternative to narrow band, frequency based systems such as GPS. As a result, multipath errors can be diminished and positional accuracy increased especially when both the transmitter and the receiver utilize UWB technology.

Lacking however is the ability to identify and interact with objects that are passive, that is, non-transmitting or non-responsive to positional inquiries. Positional determination with accuracy that would allow autonomous operations of passive objects such as parked cars, pedestrians, animals, obstacles and the like remains a challenge. These and other deficiencies of the prior art are addressed by one or more embodiments of the present invention.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

A constellation of UWB nodes fixedly positioned over a geographic area creates a network of direct and multipath solutions that enables precise positional determination of participating and nonparticipating objects alike. The constellation of UWB nodes, in which each node operates a UWB transceiver as both a monostatic and a bi-static UWB radar transceiver, allows similarly equipped mobile nodes to establish their precise spatial location. Accuracy, given current technology and regulatory limitations, is on the order of 2-5 cm however improvements in processing and relaxation of regulatory constraints can result in even finer positional accuracy. The present invention uses, among others, positional techniques such as Two-Way Ranging and Time Difference of Arrival and inter-nodal communication to ascertain the position of a similarly equipped mobile device, itself also a node.

Significantly, the same constellation can also identify and locate other, nonparticipating (passive), objects using multipath signal analysis. A resulting occupancy grid can identify unoccupied or occupied areas or volumes which may indicate open parking spots, parked cars, pedestrians, obstructions, and the like to facilitate autonomous vehicle operations, safety protocols, traffic management, emergency vehicle prioritization, collisions avoidance and the like. The present invention's fused use of UWB monostatic and bi-static UWB radar with active localization results in precise positional determination and orientation without the introduction of multipath errors that plague other systems, while actively characterizing the environment surrounding the UWB node through direct and multipath scans in order to provide situational awareness for the vehicle.

One embodiment of the present invention includes a geographic positioning system having a plurality of Ultra-Wide Band (UWB) Positional Nodes fixedly positioned within a geographic area forming a UWB constellation wherein each UWB Positional Node (UPN) operates as an UPN UWB monostatic/bi-static Radar and an UPN UWB transceiver. In another embodiment, each UPN within the UWB constellation is fixed to a separate known location within the geographic area and each UPN is within an effective UPN UWB Radar range and an effective UPN UWB transceiver range of two or more other UPNs.

At each UPN, a Radar processor is communicatively coupled to the UPN UWB Radar. The Radar processor receives both monostatic and bi-static data from the UPN UWB transceiver and each of the monostatic and bi-static data received from the UPN UWB transceiver includes a direct path return and one or more multipath returns. Using locations of the transmitter and receiver the multipath returns are then mapped on loci of constant time differences, given known transmit and receive locations.

This mapping forms a spatial “occupancy” grid of the geographic area that indicates probabilistic locations of occupied and unoccupied voxels based on coalescing arrivals of constant time differences. Each local occupancy grid may be utilized by the local device to detect nearby objects or aggregated into a global occupancy grid for increased volume coverage among the neighboring devices.

The probabilistic locations of objects in the spatial occupancy grid is based, according to one embodiment of the present invention, on mapping amplitude versus time delays in each monostatic direct path return to concentrate spheroidal distances around each UPN UWB Radar as well as mapping amplitude versus time of bi-static data to concentrate ellipsoidal distances from a time delta between bi-static direct path return and the bi-static multipath returns.

Other embodiments of the present invention include a data processor communicatively coupled to the UPN UWB transceiver wherein the data processor receives target detection lists from other UPNs within an effective UPN UWB transceiver range. Target detection lists contain the distance and amplitudes of multipath reflections which cross a specified dynamic threshold. This threshold is formed dynamically based on an ongoing assessment of the radar noise and reflective clutter signature sensed by the UPN. The data processor updates the spatial occupancy grid based on increasing probability of occupancy as clusters of locations persist over time, space, and expected target motion until the dynamic threshold is met. Exceeding this threshold indicates high probabilistic confidence of occupancy by one or more targets at a specific grid location. And responsive to the threshold being met, the UPN can declare a target with classified size and motion characteristics at the aggregated location.

The occupancy grid developed from the embodiments present herein can be inspected to identify traffic congestion within the geographic area parking availability, and can be associated with a schedule having levels of authorized occupancy for security integration within the geographic area.

Another aspect of the present invention is the inclusion of one or more movably positioned objects (vehicles) movably positioned within the geographic area wherein a location of each object is actively localized within the same coordinate system as the spatial occupancy grid and this grid is communicated to a central processor. This data transmission can be enabled by UWB or any other wired or wireless data communication system.

These movably positioned objects can include an object UWB transceiver that can operate simultaneously as a data communication device, a UWB ranging transceiver, a monostatic UWB radar, and a bi-static UWB radar, having an effective object UWB transceiver range. This transceiver performs, among other things, two-way ranging conversations with one or more UPNs. The two-way ranging conversation allows a local UWB to collect surrounding multipath information, and, according to another embodiment of the present invention, the spatial occupancy grid is updated based on the multipath information enabled by the two-way ranging conversation.

Another aspect of the present invention is a method for positional determination in a geographic area. Steps for such methodology include positioning a plurality of Ultra-Wide Band (UWB) Positional Nodes within a geographic area forming a UWB constellation wherein each UWB Positional Node (UPN) operates as an UPN UWB Radar and an UPN UWB transceiver. The process continues by receiving, at a Radar processor communicatively coupled to the UPN UWB Radar, monostatic and bi-static data from the UPN UWB Radar. Each of the monostatic and bi-static data received from the UPN UWB Radar includes a direct path return and one or more multipath returns.

The monostatic multipath returns and the bi-static multipath returns are used to form loci of constant time differences given known transmit and receive locations. Coalescing loci of constant time differences from a plurality of UPNs identify loci of probabilistic locations of objects on a spatial occupancy grid of the geographic area.

The development of these direct-path loci is based on mapping amplitude versus time delays in each monostatic direct-path return to concentrate spherical distances from each UPN UWB Radar. Bi-static multipath loci are developed by mapping amplitude versus time of bi-static data to concentrate ellipsoidal distances from a time delta between bi-static direct path return and the bi-static multipath returns.

Another aspect of a methodology for positional determination in a geographic area using UWB nodes includes receiving, at a data processor communicatively coupled to the UPN UWB transceiver and from other UPNs within an effective UPN UWB transceiver range, other loci of constant time differences between two points. The data processor then updates the spatial occupancy grid based on increasing probability of occupancy until a threshold is met indicating a high probabilistic confidence of occupancy by one or more targets at a specific grid location and, responsive to the threshold being met, forms a UPN local target detection list. This UPN local target detection list can be aggregated into a global occupancy grid shared throughout the UWB constellation.

Another aspect of the present invention includes inspecting the spatial occupancy grid to identify traffic congestion within the geographic area, to identify parking availability, and/or associating the spatial occupancy with a schedule having levels of authorized occupancy for security integration within the geographic area.

An additional feature of the present invention is performing a two-way ranging conversation between with one or more UPN, and one or more movably positioned objects within the geographic area. In such a scenario, each of the one or more movably positioned objects includes an object UWB transceiver and a UWB Radar and the two-way ranging conversation includes multipath information. With such information, the spatial occupancy grid is updated based on multipath information contained in the two-way ranging conversation.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 is a high-level block diagram of a Ultra-Wide Band Positional Node (UPN) according to one embodiment of the present invention;

FIG. 2 is a depiction of UWB constellation established within an urban geographic area, according to one embodiment of the present invention;

FIG. 3 is a representation of a two-way ranging communication interchange between a movably positioned UPN and a fixed infrastructure UPN according to one embodiment of the present invention;

FIGS. 4A and 4B show a direct and multipath waveform and associated geometry, respectively, as would be received by one or more UPNs found in a UWB constellation of the present invention;

FIG. 5 presents a graphic rendering of a locus of constant time difference of arrivals as established from multipath data according to one embodiment of the present invention between a movably positioned UPN and a fixed, infrastructure UPN;

FIG. 6 shows coalescing of a plurality of time difference of arrival presentations to identify an object probabilistically responsible for the predicate multipath signals, according to one embodiment of the present invention;

FIG. 7 shows a geographic area of a UWB constellation according to one embodiment of the present invention in which Time Distance of Arrival techniques from monostatic transmissions are used to identify the location of a movably positioned object within the UWB constellation and thereafter uses multipath returns to identify nearby objects so as to update an occupancy grid;

FIG. 8 shows a geographic area of a UWB constellation according to one embodiment of the present invention in which Two-Way Ranging between infrastructure UPNs isolates multipath signals to locate passive objects so as to update an occupancy grid;

FIG. 9 is one method embodiment of the present invention for updating an occupancy grid in a UWB constellation using multipath signals associated with Two-Way Ranging;

FIG. 10 is one method embodiment of the present invention for updating an occupancy grid in a UWB constellation using Time Distance of Arrival and Two-Way Ranging to determine the location of a movably positioned object UPN within the geographic area of the constellation as well as using multipath signals to identify objects updated in an occupancy grid; and

FIG. 11 is a recursive methodology embodiment of the present invention for updating an occupancy grid in a UWB constellation based monostatic and bi-static scans from Two Way Ranging.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

The formation of a constellation of Ultra-Wide Band (UWB) Positional Nodes combined with the fusion of monostatic and bi-static radar returns, correlated with a map of geographic area, establishes a spatial occupancy grid that, among other things, facilitates autonomous vehicular operations, enables real time traffic management, enhances vehicular and pedestrian safety, and heightens resource conservation.

The present invention crafts a constellation of UWB/Universal Positional Nodes (UPNs) that eliminate positional inaccuracies due to multipath and similar errors that plague the Global Positioning System (GPS). By using UWB Two Way Ranging and Time Distance of Arrival calculations, a precise location of a multitude of objects can be determined within a geographic area. By using multipath signals, normally discarded in prior positional techniques, the present invention identifies passive objects, both stationary and mobile, within the geographical area to create what is referred to herein as a spatial occupancy grid.

The spatial occupancy grid of the present invention can position objects within the geographic area (or more correctly, volume) that would otherwise impose barriers or impediments to navigation. By communicating this information to mobile objects (vehicles), their routes can be recomputed to provide a more efficient, timely and cost-effective means to transit the area. Similarly, the occupancy grid can identify the presence of an object, a vehicle for instance, in what is known to be a parking space. As vehicles vacate their parking location, real-time information regarding the availability of a nearby spot can be conveyed to other vehicles. These and other advantages, and their implementation methodology, are described hereafter by way of example.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying figures are provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventors to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

With respect to the present invention the following terms will interpreted as possessing the following meaning.

Ultra-Wide Band: As used herein, UWB refers to very short Radio Frequency (RF) pulses of low duty cycle ideally approaching a Gaussian Monocycle. Typically, these pulses have a relative bandwidth (i.e., signal bandwidth/center frequency) which is greater than 25%. The ultra-wide band nature of these pulses improves both angle and range resolution, which results in improved performance (e.g., greater selectivity, more sensitive motion detection). The term “wavelength”, as used herein in conjunction with UWB systems, refers to the wavelength corresponding to the center frequency of the UWB pulse.

Multilateration (MLAT) is a location technique based on the measurement of the difference in distance to two stations at known locations by broadcast signals at known times. Unlike measurements of absolute distance or angle, measuring the difference in distance between two stations results in an infinite number of locations that satisfy the measurement. When these possible locations are plotted, they form a hyperbolic curve. To locate the exact location along that curve, multilateration relies on multiple measurements: a second measurement taken to a different pair of stations will produce a second curve, which intersects with the first. When the two curves are compared, a small number of possible locations are revealed, producing a “fix”.

RAdio Detection And Ranging (RADAR) has been known for several decades. A RADAR system includes a transmitter coupled to a radar antenna which is positioned toward a target (e.g., an object or other reflective solid) for emitting radar signals to the object and a receiver coupled to the antenna (or to another antenna) for receiving radar signals reflected from the object's surface, as well as a signal processor for determining the distance on the basis of the emitted radar signals and the reflected radar signals. According to this method, the antenna driven by transmit circuitry emits a radar signal which strikes an object or surface, for example a outer surface of a vehicle. The object or surface reflects part of the emitted radar signal/wave back in the direction of the antenna, which receives and is coupled to receive circuitry that processes the reflected radar signal/wave.

Pulse radars are often used because they are relatively less sensitive to multipath clutter. One type of pulse radar system is Ultra-Wide Band (UWB) radar. UWB radar systems transmit signals across a much wider frequency range as compared to conventional narrow-band pulse radar systems. The transmitted UWB signal is significant for its very light power spectrum, which is typically lower than the allowed unintentional radiated emissions for electronics. The most common technique for generating a UWB signal is to transmit pulses with very short pulse durations (e.g., .ltoreq.1 ns). The UWB pulse covers a very large frequency spectrum, and the frequency spectrum becomes larger as the pulse becomes narrower.

Ultra-Wide Band UWB Radar uses extremely short pulses to generate a very wide bandwidth. These short pulses offer several advantages, such as high multipath resistance, covertness, lower power, and coexistence with current radio services.

The extremely narrow pulse (usually in order of few nanoseconds to few hundred picoseconds) makes it possible to build radar with much better spatial resolution and very short-range capability compared to other conventional radars. Also, the large bandwidth allows the UWB radar to get more information about the possible surrounding targets and detect, identify, and locate only the most desired target among others. Compared to a radar system with a pulse-length of one microsecond, a short Gaussian or Gaussian monopole pulse of 200 ps in width has a wavelength in free space of only 60 mm, compared to 300 m. Since the pulse length in conventional radar is significantly longer than the size of the target of interest, the majority of the duration of the returned signal is an exact replica of the radiated signal. Thus, the returned signal provides little information about the nature of the target. However, since the UWB pulse length is in the same order of magnitude or shorter than the potential targets, UWB radar reflected pulses are changed by the target structure and electrical characteristics. Those changes in pulse waveform provide valuable information such as shape and material properties about the targets. Discrimination of target using higher order signal processing of impulse signals can distinguish between materials that would not be otherwise distinguishable by the narrowband signals.

To work as UWB radar, the UWB transmitter sends a narrow pulse toward a target and an UWB receiver detects the reflected signal. This is a very simple algorithm of radar sensing which has been widely used. When the UWB pulse in propagation encounters a boundary of two types of medium with different dielectric properties, a portion of the incident electromagnetic energy is reflected back to the original medium with a reflection angle (zero reflection angle if the incident wave path is parallel to the normal line), while the other portion continues propagating through the next medium.

The Universal or Ultra-Wide Band Positional Nodes (UPNs) of the present invention comprise hardware and software components that can be installed for connectivity and positional determination among people, things, and vehicles (both air and ground). Each UPN of the present invention provides: 1) intelligent connectivity for peer to peer communications, and 2) a set of data about what is happening in the surrounding environment. With this communication and supplied data the environment becomes more intelligent for improving the safety, efficiency and movement of objects. The present invention not only improves communications and positional awareness between people and things, but with the improved communications and increased connectivity the UWB constellation will improve an object's interaction with the environment. The UWB constellation also provides real-time data and communications for precise reliable navigation.

The UWB constellation of the present invention crafts a Wireless networking/communications network using Ultra-Wide Band (“UWB”) nodes that possess radar and ranging capabilities. A constellation, as the term is used herein, is any group of two or more UWB nodes within a predetermined range, for example, within a 300-meter range of each other. One of reasonable skill in the relevant art will recognize that range limitations are a hardware and/or regulatory constraint and while the discussion that follows envisions relatively short-range communications between nodes, this discussion should in no way limit the scope of the invention if such range limitations are relaxed.

One embodiment of the present invention uses a plurality of light poles or traffic lights, each equipped with a UWB node, UPN, to create a fully connected network. The UWB nodes communicate to one another with a combination of software algorithms written, in one embodiment, with C++, and run on Linux. One of reasonable skill in the relevant art will recognize that other programing languages and operating systems can be used to facilitate the implementation of the concepts presented herein without departing from the scope and intent of the present invention. Use of the Internet and dedicated network connections can be used depending on the task performed and messaging passed between nodes. The layers in this mobility platform and the UPNs include the network connections, an Operating System such as Linux, a software frameworks such as the open source Robot Operating system (ROS), messaging, data extraction, and devices along with 3rd party products (both hardware and software) to create a fully connected network. Indeed, given typical light pole spacing and current UWB capability at least six would be in range of each other at all times forming a system that can effectively filter out/use multi-path and provide redundancy and verification. Light poles are generally spaced at optimal distance for visual light reflectivity but the present invention provides flexibility as the peer-to-peer range of the UWB modules can currently reach 350 meters.

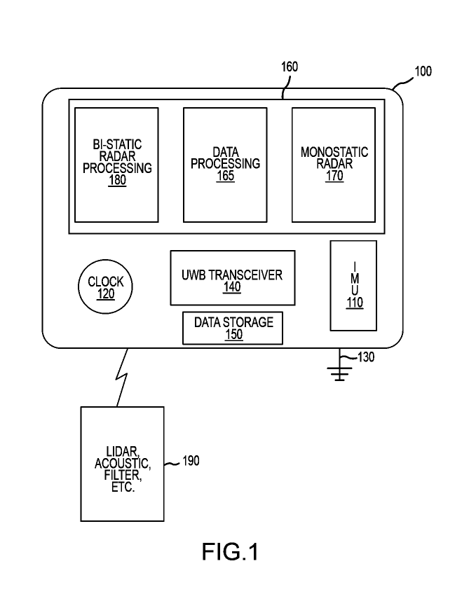

One embodiment UPNs 100 of the present invention, as shown in FIG. 1, comprise a) an inertial sensor (IMU) 110, b) a clock 120, c) wireless networking/communications network technology 130, d) UWB transceiver(s) 140 having both an UWB receiver and an UWB transmitter, e) data storage 150, (Data Set) accessible real-time to other devices and applications, f) processor(s) 160 including data 165, monostatic radar 170 and bi-static radar processing 180 modules, and g) integration capability 190 with other available components and sensors. Optional components 190 can include a camera, LiDAR, Acoustic sensors, and a fusion algorithm that correlates, filters and fuses data, voice recognition information and the like.

Within each UPN is, among other things, an UWB transceiver that emits and receives UWB pulses. Each pulse can, in the same instance, carry data, and provide meaningful information regarding the surrounding environment based on monostatic and bi-static operations. As a vehicle for transmitting information, embedded in that UWB pulse can be information that can be used by the node to assist in its positional determination. For example, upon a pulse may include a request for information from an infrastructure node such as its location. A response pulse can contain such data which can thereafter be used in TWR or TDOA calculations.

Upon issuing a request the transmission of the pulse also operates in a monostatic format. For the purpose of this invention monostatic refers to the instance in which the transmitter and receiver are substantially collocated. Thus, if a pulse is issued by a vehicle or movably positioned node, a direct path reflection and various multipath reflections received at the transmitter's location by the receiver can be processed by the processor to gain distance and occupancy grid data. In a bi-static mode of operation the same pulse seeks a response after a predefined delay. The second pulse from a known location also has a direct path and multipath reflections but the transmitter and the receiver are not collocated, though their locations are known. All pulses and data are transmitted and received by the UWB transceiver and processed, depending on the mode of operation, by the processor.

Once formed, the UPN network can have a plurality of implementations including, integration with Traffic Lights based on seeing cars, obstacles, birds, people and even animals with UWB Radar, cross-correlation of UWB radar based on tracking of people and vehicles against the constellation that can provide levels of authorization and prioritization for each, supplying data that can be used by public safety systems for predictive and re-active situations, identify available parking spots, notification of a variety of events such as: a) security breach b) illegal parking c) driveway blockage or other unsafe or illegal situations, and data that provides x, y, z, θ and a unique ID to 3^{rd} Party applications for use on external applications and applications development. For example, a radar reflectivity scan would show differences between a long trailer versus a short trailer, when a vehicle is in a turn versus going straight ahead or changes between an empty parking spot and a full parking spot. One or more modules mounted on a vehicle or infrastructure applying signal processing and pulling out desired features and data can determine changes in the environment. In the same manner boundaries can be defined, virtual designated lines in a road using a combination of software and hardware found in each UPN.

In one embodiment of the present invention, a smart light pole using the UPN technology of the present invention can include a module that a) activates a light based on UWB radar and/or constellation tracking; b) increases brightness of the lights to communicate hazards (ex: freeway debris); c) sends an alert if a vehicle is too close or about to hit something. Similarly, the present invention can use a UWB constellation to drive an autonomous personal mobility vehicle to meet a handicapped person who is parking and transport that person to an identified destination.

Key differentiators of the present invention are its use of: 1) a peer-to-peer position; 2) a time stamp for data collected; 3) the invention's storage schemes; and 4) the invention's aggregation scheme. The present invention uses, in one embodiment, a Time Series Database (TSDB) called Graphite. TSDBs store streaming values or metrics. The data sent to Graphite has the form: string, timestamp, measurement The string uniquely identifies where the data will be stored, and what it is associated with. In one embodiment, the string can take the form similar to: <Customer>/<Site>/<Asset>/<Metric>, which might look something like:

### “5D/Carlsbad-Rutherford/SLV-18dfgS1$sdir/PositionX”,1466481630,14.23072.

Data arriving in the database is stored according to a storage schema, which determines the time resolution of the data stored, and for how long, e.g. 1 second for 5 days, 1 minute for 30 days, 1 hour for 1 year, and so on. The present invention is a foundational architecture that allows multiple applications, devices, and forms of mobility to communicate in a V2X ecosystem. (Vehicle-to-Vehicle, Vehicle-to-Infrastructure, or Vehicle-to-Pedestrian)

Another aspect of the present invention includes UWB radars and/or UWB nodes being configured to form a parallel phased array system directed towards the direction of travel. Flanking the phased array system can be UWB radars and nodes that form a sparse array. Data from these two different forms of sensors can be processed to form an accurate and real-time depiction of the vehicle's environment.

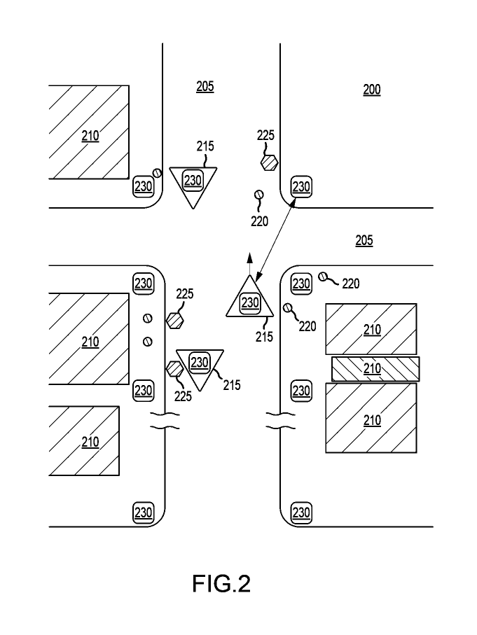

FIG. 2 presents a high-level view, according to one embodiment, of a geographic area in which a constellation 200 of networked UPNs have been established. Depicted is an urban environment (geographic area) having several streets 205, buildings 210, vehicles 215 and pedestrians 220. In this depiction, each vehicle 215 is shown as a triangle, parked cars 225 or obstacles are octagons, pedestrians 220 are small circles. At each street corner and located at certain predetermined intervals along the street are UPN 230 fixedly located within the geographic area. (shown as small squares) In one embodiment of the present invention, each UPN 230 is collocated with existing streetlights. While placement of the UPNs on streetlights utilizes an existing infrastructure device, one of reasonable skill in the relevant art will recognize that the UPNs can be affixed to buildings or virtually any other infrastructure to promote connectivity between nodes. Each infrastructure UPN is associated with a fixed, known location. Upon installation, the UPN is programmed to be aware of its precise location and orientation with respect to the geographic area. Moreover, each UPN is located within UWB transceiver 140 range of at least two other UPNs. By doing so, a connectivity mesh is formed to enhance accuracy and robustness of the network.

As previously discussed, each UPN 230, whether fixedly positioned within the geographic area as an infrastructure UPN or associated with a movably positioned object (vehicle) 215 as an object UPN, includes a UWB transceiver as well as processing capabilities for a monostatic and biostatic UWB Radar. Each UPN is also operable to ascertain information as the to the objects position in its local environment.

According to one embodiment of the present invention, the UPN constellation 200 uses this information to craft a spatial occupancy grid. The grid is communicated among the UPNs, both fixed and mobile, to enable autonomous vehicle operations as well as real-time traffic management.

Each UPN includes a UWB radar/transceiver combination capable of simultaneous UWB monostatic and bi-static operations. UWB radar operates as a pulse-echo system that clocks the two-way time of flight of a very short electrical pulse. A carrier frequency is not used; instead, an electrical voltage pulse is applied directly to the antenna. Since frequency up-conversion by a modulator is not used, there is no frequency to tune in. The UWB transmit spectrum is the Fourier transform of the emitted pulse and generally spans hundreds of megahertz to several gigahertz. It is inherently Ultra-Wide-Band, hence the designation.

By not using frequency up-conversion, the UWB spectrum is located as close to DC as possible. Since most materials exhibit rapidly increasing attenuation with frequency, UWB radar has a very significant advantage in material penetration. Tests show that 200 ps pulses freely penetrate gypsum, wood, and concrete walls. Excellent materials penetration is a fundamental advantage to UWB sensors, and will allow for their installation behind walls and appliance panels, above ceilings and below floors. UWB radar range is determined by the pulse-echo interval.

Time Modulated (TM)-UWB radars emit very short RF pulses of low duty cycle approaching Gaussian monocycle pulses with a tightly controlled pulse-to-pulse interval. It is well known that two or more of these TM-UWB radars can be arranged in a sparse array (i.e., they are spaced at intervals of greater than one quarter wavelength), preferably around the perimeter of a building. Each TM-UWB radar transmits ultra-wide band pulses that illuminate the building and the surrounding area. One or more of the radars receives signal returns, and the signal return data is processed to determine, among other things, whether a threshold condition has been triggered. One advantage of the present invention is it utilize this capability to not only detect, but also position moving (and fixed) objects.

TM-UWB Radar forms high resolution radar which give an accurate picture of the surrounding area. The current invention uses this image to, among other things, detect motion in a highly selective manner and to track moving objects within the surrounding area as well as other objects based on multipath returns. High resolution radar images are possible because the TM-UWB radars positioned in various locations form a sparse array capable of achieving high angular resolution. Angular resolution is a function of the width of the TM-UWB radar array (i.e., the wider the array, the greater the angular resolution). Conventional narrowband radars arranged in a sparse array suffer off-axis ambiguities, and are therefore not practical. However, the UWB pulses transmitted by the TM-UWB radars are sufficiently short in duration (with very few side lobes) that the radars can be used in a sparse array configuration without off-axis ambiguities. Furthermore, range ambiguities are cured by time-encoding the sequence of transmitted TM-UWB pulses.

Another advantage of the current invention is that highly selective motion detection is possible. Using the high-resolution radar images generated by the TM-UWB radar, motion can be distinguished based on criteria appropriate to the environment. For example, urban environment applications can distinguish movement around doors and sidewalks from movement on the roadway. This selectivity can result in lower false alarm rates of impending collisions.

Another advantage of the current invention is that high angular resolution may be achieved at a low center frequency. Because the transmitted UWB pulses have a large relative bandwidth, and because the radar array is wide, a lower center frequency can be maintained and still achieve a high angular resolution. Operating at a lower center frequency relaxes the timing requirements of the system, which makes it easier to achieve synchronization between the radars, and results in less complex, less expensive implementations. A low center frequency also results in UWB pulses that are able to better penetrate glossy materials and withstand weather effects.

TM-UWB radar array operates in several modes. In a first mode, each TM-UWB radar transmits and receives back scattering returns, and at least one TM-UWB radar receives forward scattering returns. In a second mode, each TM-UWB radar transmits but only one of the radars receives signal returns, both back and forward scattering. In a third mode, each TM-UWB radar transmits and receives back scattering signal returns, but neither receives forward scattering returns.

TM-UWB radios can be used to perform other functions, such as handling communications between the radars and determining the distance separating one radar from another. Using a single TM-UWB radio to perform these functions results in a cost savings. Further, by using a single TM-UWB radar for transmitting UWB pulses and handling inter-radar communications the system achieves synchronization without additional costs.

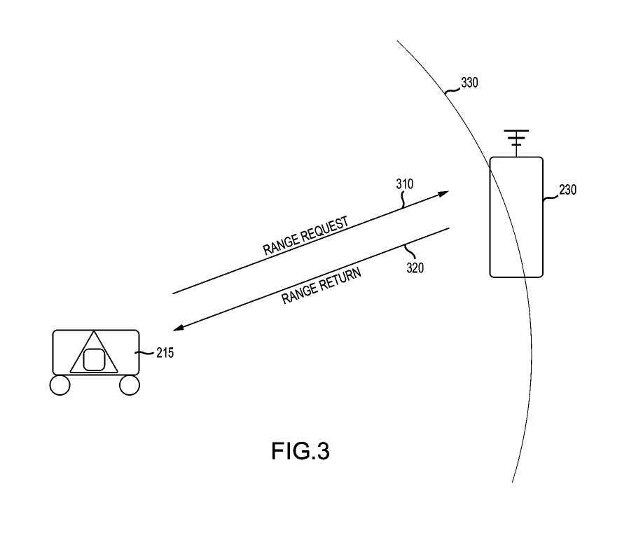

FIG. 3 is a high-level representation of the interaction between a movably positioned UPN and a fixedly positioned (infrastructure) UPN. From the perspective of the movably positioned object 215, a range request message 310 is transmitted to nearby infrastructure UPNs 230. Upon receipt of the request, the infrastructure UPN 230, after a predetermined delay, responds. The time from when the request was issued to when the response or return message 320 is received identifies the distance between the movably positioned UPN and the infrastructure UPN. Normally the computed time between request and response would identify a spheroid 330 locus of points on which the infrastructure UPN would be located. Multiple two-way ranging conversations can establish the location of the movably positioned node within the geographic area with some degree of accuracy. However, the UWB response packet can, and does, include the known location of the infrastructure UPN 230. Significantly, the response can also include information about the surrounding area.

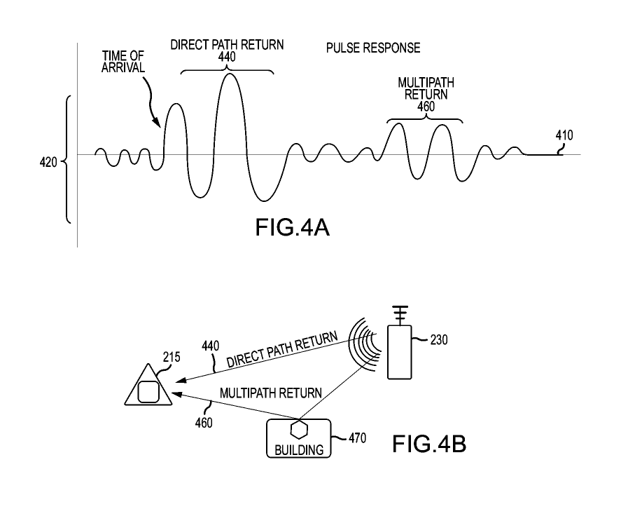

FIG. 4A is a depiction of the UWB radar pulse response. The graphical representation shows elapsed time 410 from left to right immediately prior to arrival of the responsive direct path until diminution of signal. The vertical scale 420 represents amplitude of the signal. A response issued by the infrastructure UPN 320, or even reflected energy from the initial range request issued by the movably positioned UPN, will create a single direct return, or direct path return 440, and a plurality of multipath returns 460.

Referring back to FIG. 3 in conjunction with FIG. 4, assume the movably positioned object 215 issues an omnidirectional range request (pulse) 310. As depicted in FIG. 3, the infrastructure UPN 230 will respond 320, after a predetermined delay, with its location. But other reflective energy 460 will be received from other objects 470 near the movably positioned UPN. The buildings, curb, pedestrians, parked cars, and the like will all return reflective energy. However, upon receiving the return message from the infrastructure UPN 230, these other returns can be ignored, with respect to a direct path return, and alternatively, treated as multipath return(s) 460.

With reference, again to FIG. 4A and FIG. 4B, the range return response pulse 320 from the infrastructure UPN 230 provides a sharp and recognizable direct path return 440. While beyond the scope of this disclosure, the characteristics of a direct path return 440 and that of a multipath 460 or reflected return are distinct and can be used to identify precisely the arrival time of a direct path return. The direct path return (specifically the time of arrival) 440 is primarily used for TDOA and TWR calculations. Unlike other systems that ignore the rest of the return, the present invention uses this data to identify objects within the proximity of the receiver.

The signal(s) that follows the direct path return 440 is a combination of one or more multipath reflections and noise 460. FIG. 4B illustrates that a multipath return originally emanating from a source, in this case the infrastructure UPN node 230, reflecting off of a building or similar object before arriving at the receiver 215, in this case the movably positioned UPN. Multipath signals are typically smaller in amplitude but nonetheless are distinguishable from noise. And while the depiction shown in FIGS. 4A and 4B illustrates a single direct path 440 and a single multipath return 460, each signal includes a single direct path return and a plurality of multipath returns based on nearby reflective surfaces. These multipath returns possess certain characteristics that distinguish them from the direct path return.

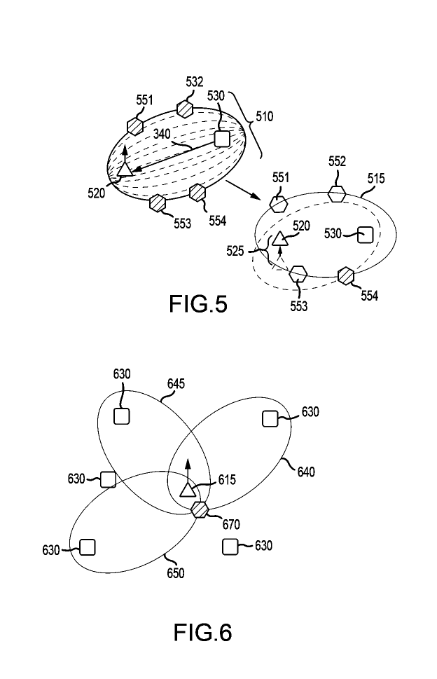

FIG. 5 illustrates an ellipsoid locus 510 of constant time differences given two known locations. In the present illustration, the distance between the moveably positioned UPN 520 and the infrastructure UPN 530 is known and is a representation of the direct path return 540. This direct path distance 540 represents the distance between two foci of the ellipsoid. More accurately the depiction is based on nonlinear regression of systems of equations, often recursively constructed using Bayesian optimization, each describing a different ellipsoidal locus of constant time difference. The elliptical volumetric shape 510 shown in FIG. 5 represents that somewhere on this ellipsoidal shape is an object 550, 552, 553, 554 that resulted in a multipath reflect/return.

While in most instances such multipath returns are problematic and are normally filtered out, the present invention uses these ancillary returns to develop a picture, or “occupancy grid”, of the surrounding environment. As shown in FIG. 5, and according to one embodiment of the present invention, as the movably positioned object 520 moves 525 a new locus 515 of constant time difference between the two points forms a new ellipsoidal shape. The multipath return again represents that somewhere on this new shape is an object that caused the multipath return. By correlating multiple returns over time as the object moves, a statistical grouping can be found and a high degree of confidence obtained as to a precise location of the object 550. In this case, of the original four depicted objects 551, 552, 553, 554, only one 554 is consistent with both renderings. Thus, the present invention identifies a relative location of the object 554. Mapped on the geographic area and overlaid with a rendering or map of the area, the object's location with respect to buildings, sidewalks and the like can be determined.

FIG. 6 presents, according to another embodiment of the present invention, another approach to use multipath return information to develop an occupancy grid in association with a constellation of networked UNPs. In the example illustrated in FIG. 6, a movably positioned object 615 again sends out range requests and receives, from infrastructure UPNs 630, range responses. Unlike the scenario depicted in FIG. 5, FIG. 6 shows that three nearby infrastructure UPNs independently process multipath scans 640, 645, 650 when they “overhear” neighboring constellation nodes responding to the movably positioned object 615. They process these returns and echo this information to the movably positioned UPN 615 as shown in FIG. 6. While shown as ellipses 640, 6+45, 650 one of reasonable skill in the relevant art will appreciate that each ellipse represents an ellipsoid and that if the transmitter and receiver are collocated the ellipsoid devolves into a spheroid.

As with the prior example, the ellipsoid represents a collection of points relative to the source of the multipath return. By overlaying each of these ellipsoids and identifying their intersection the likelihood that a portion of the occupancy grid contains an object 670 becomes extremely high. According to one embodiment of the present invention, a threshold is dynamically determined and upon a measure of confidence that an object 670 exists a certain location exceeds that threshold, the occupancy grid is updated to reflect the presence of an object.

As one of reasonable skill in the relevant art can appreciate, each infrastructures UPN, within its effective range, will consistently identify permanent structures. Buildings, curbs, light poles, stairs and similar permanent structures can be included in the occupancy grid as a baseline environment. As new objects are identified, the occupancy grid can be updated and propagated throughout the UPN network or constellation to create a global occupancy grid.

As a matter of illustration, consider a parking spot located on the side of a street. According to one embodiment of the present invention, a constellation of fixed infrastructure UPNs establishes a network environment over a geographic area. Overlaid on the geographic area is a map or satellite rendering. As the position of each fixed infrastructure UPN is known, the map can be aligned to accurately reflect the environment. Assume that a local area within the constellation allows parking along the curb. The curb, sidewalk, and buildings are permanent and their reflective multipath returns as well as direct returns will be mapped and correlated to the rendering.

As a new object, even one that does possess a movably positioned UPN, occupies a parking space the infrastructure UPNs and any movably positioned UPNs in the local area can identify that parking spot as occupied. Dynamic operation can improve confidence by analyzing changes through space and time. That information can be communicated to other objects, several blocks away, that parking is not available, or, if the vehicle leaves, a spot has recently been vacated.

Similarly, pedestrians, trucks, or other impediments to traffic can be identified and communicated thought the UPN constellation, or this data uploaded to a secondary network using Wi-Fi, cell phone, or wired means at UPNs equipped with data exfiltration support, to promote traffic management, safety operations, emergency response planning and the like.

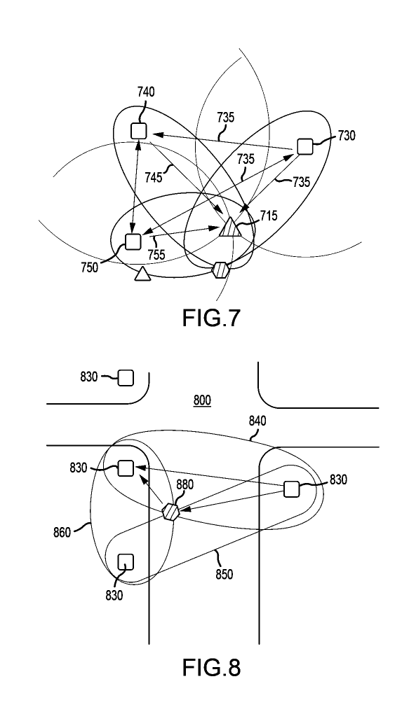

In another embodiment of the present invention and as illustrated in FIG. 7, a movably positioned object 715 can determine its location using Time Distance of Arrival (TDOA). In TDOA, or “inverse TDOA”, as it is sometimes referred to, an object, in this case an infrastructure UPN 730, transmits a signal 735 at a precise time. Other nearby infrastructure UPNs 740, 750 receive the signal and note the time of reception. These neighboring UPNs then transmit signals 745, 755 at precise time delays relative to the initial reception. A mobile UPN 715 receives this traffic and computes its location based on the difference in time between various receptions. And whenever a movably positioned object receives any infrastructure transmission it recursively updates its own location, develops a multipath scan of its surrounding volume, and updates its occupancy grid.

At a single point in time, if a movably positioned object receives four or more transmissions it can use multilateration to identify its position. Using recursive techniques, the position update may occur with each new transmission. Since most spatial positioning is assumed to occur on the surface of the earth the fourth sphere can be implied eliminating the need for a fourth geometric basis. FIG. 7 illustrates three ellipsoids generated by each transmission from the infrastructure UPNs and received by the movably positioned object. As the position of each infrastructure UPN is fixed and known, and the position of the movably positioned UPN is now known, multipath returns from the original transmission from each infrastructure UPN can be analyzed with respect to location rather than time.

As with FIG. 6, a loci of constant time difference between three sets of two point pairs follow ellipsoidal shapes. As theses shapes coalesce at a common point or grid coordinate, according to one embodiment of the invention, an object is identified and the occupancy grid updated. The spatial occupancy grid of the geographic indicates probabilistic locations of objects based on mapping amplitude versus time delays in each monostatic direct path return to concentrate ellipsoidal distances around each UPN UWB Transceiver and the mapping of amplitude versus time of bi-static returns to concentrate ellipsoidal distances from a time delta between bi-static direct path return and the bi-static multipath returns. If the movable device is equipped with co-located transmitter receiver (transceiver) for monostatic radar a set of concentric spheroids of varying weights can also be mapped to spatial coordinates around instantaneous locations of the movable device.

Another embodiment of the present invention fuses object data found through multipath return determination using transmissions from collocated receiver (monostatic Radar) with that found by transmissions from distributed receivers (bi-static Radar). During a Two-Way Ranging conversation, initiated by a movable device, monostatic scans are generated during request packet transmission and bi-static scans during response packet reception. In doing so, not only are inaccuracies of the direct path positional determination reduced but confidence as to location of other objects within the environment area are enhanced.

FIG. 8 presents yet another embodiment of the present invention to utilize multipath return in crafting an occupancy grid in a geographic area associated with a constellation of UPNs. FIG. 8 shows an urban environment 800 with four infrastructure UPNs 830. Each UPN's location is known and each can establish both a two-way ranging localization architecture as well as a time distance of arrival location architecture. In this instance, the purpose of the communication or transmission is not to identify or even verify the location of the infrastructure UPN. Those locations are fixed and known. But rather, it is to collect multipath return information and craft loci 840, 850, 860 of constant time differences rendering ellipsoidal shapes between the various combinations of the UPNs. Without the presence or interaction of a movably positioned object or movable UPN, the constellation itself can identify and update the environment area of new objects 880. In such a manner, the occupancy grid of the entire constellation can remain up to date on a real-time basis.

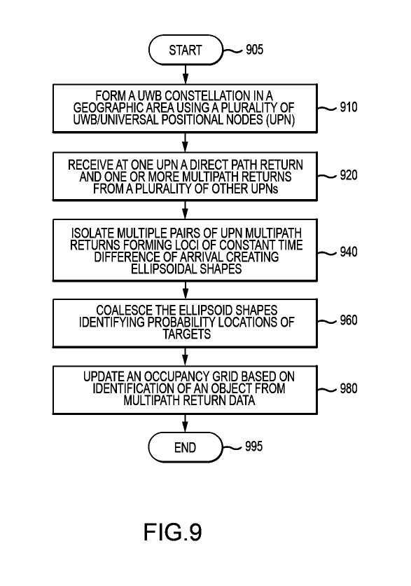

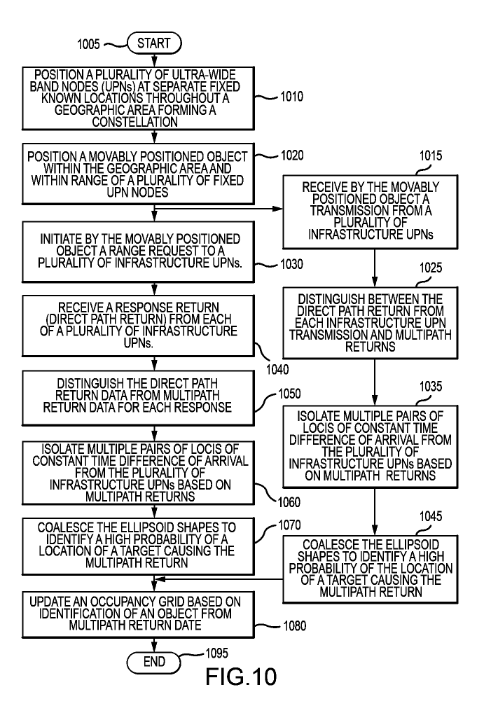

FIGS. 9 and 10 depicts flowchart examples of the methodology which may be used to identify objects within a constellation of UWB infrastructure nodes by analyzing multipath data found in monostatic and bi-static UWB radar returns. In the following description, it will be understood that each block of the flowchart illustrations, and combinations of blocks in the flowchart illustrations, can, in certain embodiments, be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware or special purpose computer systems that perform the specified functions or steps, or combinations of special purpose hardware and computer instructions.

FIG. 9 presents one method embodiment of the present invention for establishing an occupancy grid within a geographic area associated with a constellation of UWB positional nodes. The process begins 905 with the establishment 910 of a constellation of UWB positional nodes. As previously discussed each UPN is distributed throughout a geographic area such that each node is within UWB transceiver/Radar range of two or more other nodes. In one embodiment UPNs are associated with streetlights, traffic signals, or other established geographic infrastructure. Each infrastructure UPN is fixed with a known location. These locations are memorialized in a list shared among all nearby nodes so that each UPN not only knows its position but those of other nodes within its effective transceiver/Radar range.

Each UPN is operable to receive 920 transmissions from other UPNs utilizing a Time Distance of Arrival (TDOA) or monostatic radar return schema of positional determination. Moreover, each UPN can conduct Two-Way Ranging (TRW) and bi-static radar positional techniques in which a range request is transmitted by a requesting node and a range response is transmitted by a responding node. In both instances, the location of the transmitting and the receiving nodes are known. In both cases, a direct path return is received and a plurality of multipath returns as well.

One aspect of the present invention isolates 940 pairs of multipath returns from two or more responding UPNs, forming loci of constant time difference of arrival that can be represented as a plurality of ellipsoids. These ellipsoids denote multipath returns reflected from an object. Coalescing 960 the foci at a common point in time identifies probabilistic locations of reflective targets. These identified targets are distinguished from known, permanent infrastructure reflectivity such as buildings, curbs, light posts and the like, and these multipath returns represent vehicles (parked or moving), pedestrians, obstructions, construction, etc.

One of reasonable skill in the relevant art will appreciate that this process can be carried out by each of the plurality of UPNs to achieve a robust, accurate and reliable representation of objects located within the geographic area. Overlaying a map on the geographic area results in an occupancy grid that is updated 980, according to one embodiment of the present invention, in real-time, based on analysis of multipath data.

FIG. 10 presents another method embodiment of the present invention for establishing an occupancy grid within a geographic area associated with a constellation of UWB positional nodes and movably positioned object UPNs. As with the methodology shown in FIG. 9, a constellation of UWB Positional Nodes with known, fixed locations 1010 is created. (also referred to as “infrastructure UPNs”) Each UPN includes a UWB transceiver as well as monostatic and bi-static UWB radar processing capabilities. Each movably positioned object UPN also includes a UWB transceiver and UWB monostatic and bi-static Radar capacities.

Within the geographic area of the UPN constellation a movably positioned object UPN, for example a UWB-equipped vehicle, is positioned 1020 to be within effective range of two or more infrastructure UPNs. According to one embodiment of the present invention, the movably positioned object initiates 1030 a range request message to two or more nearby infrastructure UPNs. In each case, the infrastructure UPNs respond after a predetermined delay. Knowing the time at which the request was sent, the delay and the time at which the response was received 1040 enables the movably positioned UPN to ascertain the distance between the movably positioned UPN and the infrastructure UPN. Receiving multiple responses from multiple nearby infrastructure UPNs enables the movably positioned UPN to refine its precise location. This is accomplished using the direct path return of the response message. And, included with each response message is data identifying the location of the responding UPN.

The response message further includes multipath signals. These signals are reflections of the direct path signal that arrive at the movably positioned UPN after the direct path signal, yet mimic the direct-path signal. Multipath signals are the primary source of error in positional systems such as GPS and the like.

According to one embodiment of the present invention the multipath signals are distinguished 1050 from the direct path signals to form 1060 loci of constant time difference of arrival representations. These representations are coalesced 1070 identifying a high probability of the location of a reflective object responsible for the multipath return.

Using this information, an occupancy grid of the geographic area is updated 1080 and shared among the UPNs of the constellation as well as any movably positioned object UPNs within the geographic area.

In another embodiment of the present invention and also illustrated in FIG. 10, the movably positioned object receives 1015 signals broadcast from two or more infrastructure UPNs. Knowing the time at which the signal was broadcasted and time upon which it was received, the movably positioned UPN can determine its range and thus its position using multilateration. As with the prior embodiment, each direct path return generally includes one or more multipath 1025 returns. Each of these multipath returns along with the known location of the transmitter and the receiver generates 1035 a locus of constant time differences.

Coalescing loci 1045 of constant time difference of arrival from different infrastructure UPNs identifies a probabilistic location of the object that is responsible for the multipath signals. The location of this object is imported to the overlaid map on the geographic area forming an occupancy grid.

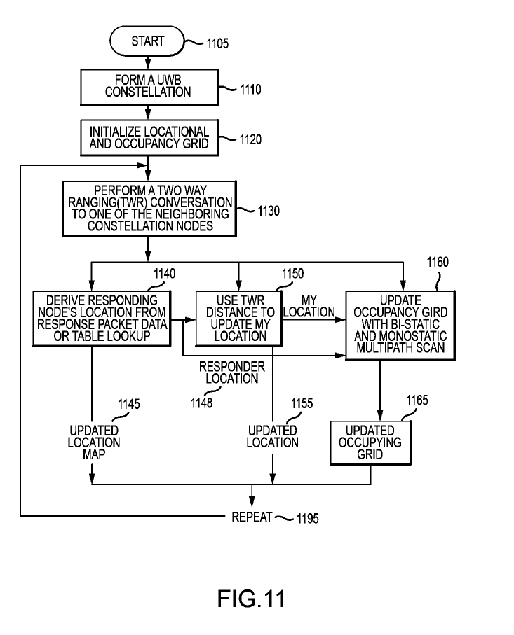

FIG. 11 is one embodiment of a recursive methodology for updating an occupancy grid in an UWB constellation according to one embodiment of the present invention. The process begins 1105 with the formation 1110 of an UWB constellation in a geographic area. The location of each UWB positional node (UPN) is known and recorded.

An occupancy grid is initialized 1120 based on the location of the UPNs within the geographic area. For example, a plurality of UPNs are located on streetlights on street corners the occupancy grid is initialized to reflect these locations. Thereafter at least one of the UPNs performs 1130 a Two-Way ranging conversation with one of its neighboring UPNs. From this conversation, the responding UPN's location is derived 1140 from either information in the response packet or from a look-up table, and its location is updated 1145 on the occupancy grid. At the same time the distance between the requesting UPN and the responding UPN is updated 1150 and the requesting node's location is updated 1155. Using the known location of the requesting UPN and the known location of the responding UPN, both monostatic and bi-static multipath scanning can take place.

Coalescing multipath scans can be identified 1160 on the three-dimensional occupancy grid as voxels having a high probability of occupancy. Over time sequential occupancy and vacancy of grid voxels can indicate a mobile object while sustained occupancy may lead to the conclusion that an object is at rest. Once the occupancy grid is updated 1165, the process begins again, in a recursive 1195 cycle to maintain an accurate grid characterization.

Embodiments of the present invention establish a constellation of UWB nodes over a geographic area in which precise positional determination of participating movably-positioned object UPNs can occur. Significantly, the same constellation with and without the use of the movable nodes can also identify and locate other objects using multipath signal analysis. The resulting occupancy grid can identify parked cars, pedestrians, obstructions, and the like to facilitate autonomous vehicle operations, safety protocols, traffic management, emergency vehicle prioritization, collisions avoidance and the like. The present invention's fused use of UWB monostatic and bi-static UWB radar data results in precise positional determination and orientation without the introduction of multipath errors that plagues other systems.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

In a preferred embodiment, the present invention can be implemented in software. Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, flash memory or the like. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform particular tasks or implement particular abstract data types. Moreover, those skilled in the art will appreciate that the invention can be practiced with other computer system configurations, including hand-held devices, multi-processor systems, microprocessor-based or programmable consumer electronics, network PCs, minicomputers, mainframe computers, and the like. The invention may also be practiced in distributed computing environments where tasks are performed by remote processing devices that are linked through a communications network as well as in an independent computing environment. In a distributed computing environment, program modules may be located in both local and remote memory storage devices.

An exemplary system for implementing the invention includes a general-purpose computing device such as a personal communication device or the like, including a processing unit, a system memory, and a system bus that connects various system components, including the system memory to the processing unit. The system bus may be any of several types of bus structures including a memory bus or memory controller, a peripheral bus, and a local bus using any of a variety of bus architectures. The system memory generally includes read-only memory (ROM) and random-access memory (RAM). A basic input/output system (BIOS), containing the basic routines that help to transfer information between elements within the personal computer, such as during start-up, is stored in ROM. The computer may further include a hard disk drive or similar storage device for reading from and writing to a hard disk, a magnetic disk drive for reading from or writing to a removable magnetic disk or the like. The hard disk drive and magnetic disk drive are typically connected to the system bus by a hard disk drive interface and a magnetic disk drive interface, respectively. The drives and their associated computer-readable media provide non-volatile storage of computer readable instructions, data structures, program modules and other data for the personal computer. Although the exemplary environment described herein employs a hard disk and a removable magnetic disk, it should be appreciated by those skilled in the art that other types of computer readable media which can store data that is accessible by a computer may also be used in the exemplary operating environment.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

While there have been described above the principles of the present invention in conjunction with the establishment of a UWB positional constellation, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A geographic positioning system, comprising:
a plurality of fixedly positioned Ultra-Wide Band (UWB) transmitters, wherein each fixedly positioned UWB transmitter is located at a known location;
one or more transmissions emanating from one or more of the plurality of fixedly positioned UWB transmitters wherein each of the one or more transmissions results in a direct path return and one or more multipath returns; and
one or more mobile UWB receivers configured to receive the direct path return and one or more multipath returns.

2. The geographic positioning system of claim 1, wherein the one or more mobile UWB receivers measures one or more associations, wherein each association is between a multipath return and a time delay and wherein the time delay is a measure of time between the multipath return and the direct path return.

3. The geographic positioning system of claim 1, further comprising a location of each of one or more objects in proximity of the one or more mobile UWB receivers based on a mapping each multipath return to a spatial coordinate system.

4. The geographic positioning system of claim 1, further comprising an occupancy grid based on a mapping the one or more identified objects.

5. The geographic positioning system of claim 1, wherein the one or more transmissions are synchronized in time.

6. The geographic positioning system of claim 1, wherein the one or more mobile UWB receivers each includes a mobile UWB transmitter and wherein the mobile UWB transmitter transmits a mobile transmission resulting in a mobile direct path return and one or more mobile multipath returns, both received by the mobile UWB receiver, wherein the one or more mobile multipath returns are created by a reflection from one or more objects in proximity of the one or more mobile UWB receivers.

7. The geographic positioning system of claim 1, wherein a first mobile UWB receiver receives one or more mobile transmission multipath returns emanating from a second mobile UWB transmitter created by a reflection from one or more objects in proximity of the first mobile UWB receiver.

8. A geographic positioning system, comprising:
a plurality of Ultra-Wide Band (UWB) Positional Nodes fixedly positioned within a geographic area forming a UWB constellation wherein each UWB Positional Node (UPN) operates as a UPN UWB transceiver;
at each UPN, a processor communicatively coupled to the UPN UWB transceiver wherein the processor receives monostatic and bi-static data generated by the UPN UWB transceiver and wherein each of the monostatic and bi-static data from the UPN UWB transceiver includes a direct path return and one or more multipath returns and wherein the monostatic multipath returns and the bi-static multipath returns are mapped on loci of constant time differences given known transmit and receive locations; and
a spatial occupancy grid of the geographic area indicating probabilistic locations of objects based coalescing loci of constant time differences.

9. The geographic positioning system of claim 8, wherein probabilistic locations of objects in the spatial occupancy grid is based on mapping amplitude versus time delays in each monostatic direct path return to concentrate spheroidal distances around each UPN UWB transceiver and mapping amplitude versus time of bi-static data to concentrate ellipsoidal distances from a time delta between bi-static direct path return and the bi-static multipath returns.

10. The geographic positioning system of claim 8, further comprising, at each UPN, a data processor communicatively coupled to the UPN UWB transceiver wherein the data processor generates multipath scans from transmissions of other UPNs within an effective UPN UWB transceiver range that represent other loci of constant time differences between two points and wherein the data processor updates the spatial occupancy grid based on increasing probability of occupancy until a threshold is met indicating a high probabilistic confidence of occupancy by one or more targets at a specific grid location and wherein responsive to the threshold being met the UPN forms a UPN local target list.

11. The geographic positioning system of claim 10, further comprising a global occupancy grid by aggregating each UPN local target list.

12. The geographic positioning system of claim 8, wherein inspection of the spatial occupancy grid identifies traffic congestion within the geographic area.

13. The geographic positioning system of claim 8, wherein the spatial occupancy grid identifies parking availability within the geographic area.

14. The geographic positioning system of claim 8, wherein the spatial occupancy grid is associated with a schedule having levels of authorized occupancy to identify security integration within the geographic area.

15. The geographic positioning system of claim 8, further comprising one or more movably positioned objects movably positioned within the geographic area wherein a location of each object is associated with the spatial occupancy grid and communicated to each UPN within an effective UPN UWB transceiver range.

16. The geographic positioning system of claim 8, further comprising one or more movably positioned objects within the geographic area wherein each of the one or more movably positioned objects includes an object UWB transceiver having an effective object UWB transceiver range performing a two-way ranging conversation with one or more UPNs wherein the two-way ranging conversation includes multipath information, and wherein the spatial occupancy grid is updated based on the multipath information contained in the two-way ranging conversation.

17. The geographic positioning system of claim 8, wherein each UPN within the UWB constellation is fixed to a separate known location within the geographic area and wherein each UPN is within an effective UPN UWB Radar range and an effective UPN UWB transceiver range of two or more other UPNs.

18. A method for positional determination in a geographic area, the method comprising:
positioning a plurality of Ultra-Wide Band (UWB) Positional Nodes within a geographic area forming a UWB constellation wherein each UWB Positional Node (UPN) operates as an UPN UWB transceiver;
receiving, at a processor communicatively coupled to the UPN UWB transceiver, monostatic and bi-static data from the UPN UWB transceiver wherein each of the monostatic and bi-static data includes a direct path return and one or more multipath returns;
mapping the monostatic multipath returns and the bi-static multipath returns on loci of constant time differences given known transmit and receive locations; and
coalescing loci of constant time differences from a plurality of UPNs indicating probabilistic locations of objects on a spatial occupancy grid of the geographic area.

19. The method for positional determination in a geographic area of claim 18, further comprising mapping amplitude versus time delays in each monostatic direct path return to concentrate spheroidal distances around each UPN UWB Radar.

20. The method for positional determination in a geographic area of claim 19, further comprising mapping amplitude versus time of bi-static data to concentrate ellipsoidal distances from a time delta between bi-static direct path return and the bi-static multipath returns.

21. The method for positional determination in a geographic area of claim 18, further comprising receiving, at the processor and from other UPNs within an effective UPN UWB transceiver range, other loci of constant time differences between two points, wherein the data processor generates multipath scans from transmissions of other UPNs and updates the spatial occupancy grid based on increasing probability of occupancy until a threshold is met indicating a high probabilistic confidence of occupancy by one or more targets at a specific grid location and wherein responsive to the threshold being met forming a UPN local target list.

22. The method for positional determination in a geographic area of claim 21, further comprising aggregating each UPN local target list forming a global occupancy grid shared throughout the UWB constellation.

23. The method for positional determination in a geographic area of claim 18, further comprising inspecting the spatial occupancy grid to identify traffic congestion within the geographic area.

24. The method for positional determination in a geographic area of claim 18, further comprising inspecting the spatial occupancy grid to identify parking availability within the geographic area.

25. The method for positional determination in a geographic area of claim 18, further comprising associating the spatial occupancy with a schedule having levels of authorized occupancy to identify security integration within the geographic area.

26. The method for positional determination in a geographic area of claim 18, further comprising performing a two-way ranging conversation between with one or more UPN and one or more movably positioned objects within the geographic area wherein each of the one or more movably positioned objects includes an object UWB transceiver and wherein the two-way ranging conversation includes multipath information, and wherein the spatial occupancy grid is updated based on multipath information contained in the two-way ranging conversation.

27. The method for positional determination in a geographic area of claim 18, wherein each UPN within the UWB constellation is fixed to a separate known location within the geographic area and wherein each UPN is within an effective UPN UWB Radar range and an effective UPN UWB transceiver range of two or more other UPNs.
